(19) United States
(12) Patent Application Publication
(10) Pub. No.: US 2016/0352861 A1
(43) Pub. Date: Dec. 1, 2016

(54) ADMINISTERING MEMBER PROFILES ON A SOCIAL NETWORKING WEB SITE

(71) Applicant: LinkedIn Corporation, Mountain View, CA (US)

(72) Inventors: Christopher T. White, Los Gatos, CA (US); Christopher McLean, Sunnyvale, CA (US); Arvind Mani, Los Altos, CA (US); Madhushree Gupta, Saratoga, CA (US); Rastan Boroujerdi, Menlo Park, CA (US)

(21) Appl. No.: 14/726,498

(22) Filed: May 30, 2015

(51) Int. Cl. H04L 29/08; H04L 29/06; G06F 3/0481; G06F 3/0484; G06F 17/24; G06F 17/22

(52) U.S. Cl. CPC H04L 67/306; H04L 67/02; G06F 17/24; G06F 17/2247; G06F 3/0481; G06F 3/0484; H04L 63/10; H04L 63/08

(57) ABSTRACT

Techniques for administering member profiles on a social networking web site. In some embodiments, for example, a computer-implemented method comprises: sending a browser cookie to a computing device of an authenticated user containing information representing at least one administrative privilege the authenticated user has on a social networking web site; receiving a request for a profile page of a member of a social network from the authenticated user; determining, based on the browser cookie, if the request is made with the at least one administrative privilege; and if so, causing at least a portion of the profile page of the member to be displayed to the authenticated user with a visual indication on the portion of the profile page that the authenticated user currently has the at least one administrative privilege with respect to the member's profile page.

### TECHNICAL FIELD

The disclosed embodiments relate generally to social networking web sites and, more particularly, to social networking web sites that serve web pages providing profiles of their members.

### BACKGROUND

The approaches described in this section are approaches that could be pursued, but not necessarily approaches that have been previously conceived or pursued. Therefore, unless otherwise indicated, it should not be assumed that any of the approaches described in this section qualify as prior art merely by virtue of their inclusion in this section.

As social networking web sites become more popular, and the number of users of a given social networking web site increase, it has become a significant challenge to design systems, methods, and graphical user interfaces that allow users, such as customer (member) support personnel, to easily administer member profile data presented in member profile pages on a social networking web site. This challenge is particularly significant for access controlled social networking web sites, which control the information a given user can view and edit on a given member's profile page. This situation is unfortunate because the member profile page is the gateway on the web site though which members interact with other members on the web site. If a member, even with the aid of a member support representative, cannot easily configure their member profile page to appear on the web site as desired, then the member may be frustrated with the web site or leave the web site altogether.

Some social networking web sites have resorted to building dedicated member support tools with their own specialized graphical user interfaces for administering member profile data. Due to their separate nature, these dedicated graphical user interfaces are often out-of-date with respect to the latest member profile graphical user interface available to members on the web site. As a result, there is often member profile data that the member can modify using the latest member profile graphical user interface but that a member support representative cannot modify using the graphical user interface of the member support tool.

Accordingly, there is a need for systems, methods, and graphical user interfaces for more easily administering member profile pages on a social networking web site. Such systems, methods, and graphical user interfaces increase effectiveness and efficiency of member support representatives in maintaining and troubleshooting the profile pages of members on the web site.

### BRIEF DESCRIPTION OF THE DRAWINGS

For a better understanding of the aforementioned embodiments of the invention as well as additional embodiments thereof, reference should be made to the Description of Embodiments below, in conjunction with the following drawings in which like reference numerals refer to corresponding parts throughout the figures.

FIG. 1 is a block diagram illustrating computing environment that includes a social networking web site computer system in accordance with some embodiments.

FIG. 2 shows examples of possible graphical user interface elements that may be displayed on the profile page of a member of a social network when a user has at least one administrative privilege with respect to the member's profile page in accordance with some embodiments.

FIG. 3 shows an example of a possible graphical user interface elements that may be displayed on the profile page of a member of a social network after a user has logged out of an administrative mode in accordance with some embodiments.

FIG. 4 is flowchart of a process for enabling administration of a target member's profile page on a social networking web site in accordance with some embodiments.

FIG. 5 is a block diagram that illustrates an example computing device suitable for implementing embodiments of the present invention.

FIG. 6 is a block diagram of an example software system that may be employed for controlling the operation of computing device of FIG. 5.

### DESCRIPTION OF EMBODIMENTS

In the following description, for the purposes of explanation, numerous specific details are set forth in order to provide a thorough understanding of the present invention. It will be apparent, however, that the present invention may be practiced without these specific details. In other instances, well-known structures and devices are shown in block diagram form in order to avoid unnecessarily obscuring the present invention.

### Overview

The deficiencies discussed in the Background section above and other problems associated with administering member profile pages on social networking web sites may be reduced or eliminated by the disclosed system. In some embodiments, the system includes one or more hardware processors, memory, and one or more programs stored in the memory. The one or more programs may be configured to send, via at least one of the processors, a browser cookie to a computing device of an authenticated user. The browser cookie may contain information representing at least one administrative privilege the authenticated user has on a social networking web site. The one or more programs may be further configured to receive, via at least one of the processors, a request for a profile page of a member of a social network. The request may be sent from the computing device of the authenticated user and may include a browser cookie containing information representing the at least one administrative privilege. The member whose profile page is requested may not be the authenticated user. For example, the authenticated user may be an administrator of the social networking web site and the member may be an ordinary (non-administrative) user of the social networking web site. The one or more programs may be further configured to determine, via at least one of the processors, based on the browser cookie in the request, if the request is made with the at least one administrative privilege, and if so, cause, via at least one of the processors, at least a portion of the profile page of the member to be displayed to the authenticated user with a visual indication on the portion of the profile page that the authenticated user currently has the at least one administrative privilege with respect to the member's profile page.

In one aspect of the invention, a computer-implemented method, for use in conjunction with one or more computing devices of a social networking web site, comprises: sending a browser cookie to a computing device of an authenticated user, the browser cookie containing information representing at least one administrative privilege the authenticated user has on the social networking web site; receiving a request for a profile page of a member of a social network, the request sent from the computing device of the authenticated user and including a browser cookie containing information representing the at least one administrative privilege; wherein the member is not the authenticated user; determining if the request is made with the at least one administrative privilege, based on the browser cookie in the request; and if the request is made with the at least one administrative privilege, then causing at least a portion of the profile page of the member to be displayed to the authenticated user with a visual indication on the portion of the profile page that the authenticated user currently has administrative privileges with respect to at least the member's profile page.

In another aspect of the invention, a graphical user interface on a video display of, or operatively coupled to, a computing device of an authenticated user of a social networking web site comprises at least a portion of a profile page of a member, other than the authenticated user, of a social network. In response to receiving a request for the profile page of the member from the computing device of the authenticated user, an administrative privilege that the authenticated user has with respect to the member's profile page is determined based on a browser cookie in the request, and a visual indication that the authenticated user has the administrative privilege with respect to the member's profile page is displayed on the portion of the profile page.

In yet another aspect of the invention, one or more non-transitory computer-readable media storing one or more computer programs. The one or more computer programs comprise instructions, which when executed by one or more computing devices of a social networking web site, cause the one or more computing devices to: send a browser cookie to a computing device of an authenticated user, the browser cookie containing information representing at least one administrative privilege the authenticated user has on the social networking web site; receive a request for a profile page of a member of a social network, the request sent from the computing device of the authenticated user and including a browser cookie containing information representing the at least one administrative privilege; wherein the member is not the authenticated user; determine if the request is made with the at least one administrative privilege, based on the browser cookie in the request; and cause at least a portion of the profile page of the member to be displayed to the authenticated user with a visual indication on the portion of the profile page that the authenticated user currently has the at least one administrative privilege with respect to the member's profile page, if the request is made with the at least one administrative privilege.

The disclosed embodiments allow select members of a social networking web site to more easily and efficiently administer the member profile pages of other members.

### Social Networking Web Site System

Embodiments of a computer system providing a social networking web site, graphical user interfaces for such web sites, and associated processes performed by such computer systems are described. In some embodiments, the computer system includes one or more hardware processors configured to execute one or more sets of processor-executable instructions (e.g., software). The instructions, when executed by the processors, perform the associated processes including driving, via a communications network, the graphical user interfaces presented at computing devices of users of the web site.

The graphical user interfaces may include web pages that contain information about members of a social network maintained by a social networking service that operates the social networking web site. The social networking service may maintain (e.g., in one or more databases) data (profile data) about each member of the social network. Such profile data may include various information about the member including, but not limited to, the member's bibliographic information (e.g., name, title, address, contact information, etc.), the member's employment history or experience (e.g., companies for which the member currently works for or has worked for in the past), the member's education (e.g., colleges or universities the member attends or attended in the past), the member's skills (e.g., professional skills the member has acquired), the member's languages (e.g., spoken languages the member is fluent in), the member's interests (e.g., the member's musical, television, movie, art, or athletic interests), or the member's group memberships (e.g., professional, academic, or social groups to which the member belongs).

Profile data for a member may also include the member's “connections” in the social network. The connections may be represented in the profile data for the member as a set of other members that have mutually agreed through the social networking service that a certain personal relationship (friend, family, colleague, classmate, etc.) exists between the members. This set of members is sometimes referred to as the member's “friends” or “connections” in the social network.

In some instances, a member of the social network is not a person. For example, the member may be a company, group, association, school, advertisement, job posting, or other entity. More generally, a member of the social network may be any entity (e.g., person, place, or thing) for which the social networking service maintains profile data and for which a profile page of the entity is available on the social networking web site. The information about the member that is maintained in the profile data may vary depending on the type of member. Further, the information may be specific to the type of member. For example, profile data for a university may contain a list of famous or notable alumni which would not be applicable to other types of members.

Profile data for a member of the social network may also include real-time information pertaining to or about the member, or the member's connections in the social network. Such real-time information may include, but is not limited to, recent posts to the social networking web site by the member, recent posts to the social networking web site by another member where the post references or tags the member, recent posts to the social networking web site by the member's connections, regardless if they reference or tag the member, or sponsored posts that advertise a particular good or service to the member.

A post may include text, graphics, images, videos, hyperlinks, or some combination thereof presented on the social networking web site and may have an associated post date/time that may be used to chronologically order the post with respect to other posts to the social networking web site. For example, the associated post date/time of recent posts may be used to chronologically order the posts in a news feed or other feed presented on the member's profile page. However, posts are not limited to being presented on the social networking web site only in chronological order. Post date/time may just be one among a number of factors that determine the display order of posts. For example, a “popular” post by one of the member's connections that has been viewed by many members may be displayed on the member's profile page before a more recent post from another of the member's connections, or a new post from one of the member's connections may not be displayed on the member's profile page at all if is not deemed according to a computer algorithm to be sufficiently relevant or interesting to the member (e.g., because the member rarely views the member's profile page). In some contexts, a post may also be referred to as a “status update” or a “tweet” and such terms may be used interchangeably with the term “post,” as well as any other terms one skilled in the art would consider interchangeable with the term “post.”

Profile data for a member of the social network may also include comments on the member's profile made by other members of the social network. Here, a comment, like a post, may include text, graphics, images, video, hyperlinks, or some combination thereof presented on the member's profile page and may have an associated comment date/time that may be used to order the comment with respect to other comments. However, a comment may differ from a post in that comments are typically part of a threaded discussion, while posts typically are not threaded. By threaded discussion, it is meant that a comment typically belongs to a set of comments that all pertain to a particular topic (e.g., a particular post). Often, one comment will reply to another comment in the threaded discussion. Further unlike posts, which are sometimes displayed in out-of-chronological order based on perceived significance to the member or other factors, comments are usually displayed in chronological order. However, in some cases, the display order of comments may also out-of-chronological order where the display order is selected to convey which comments reply to earlier comments. In this case, the comments may be displayed with a nested or hierarchical arrangement to convey reply or sub-discussion relationships between and among comments.

### Example Computing Environment

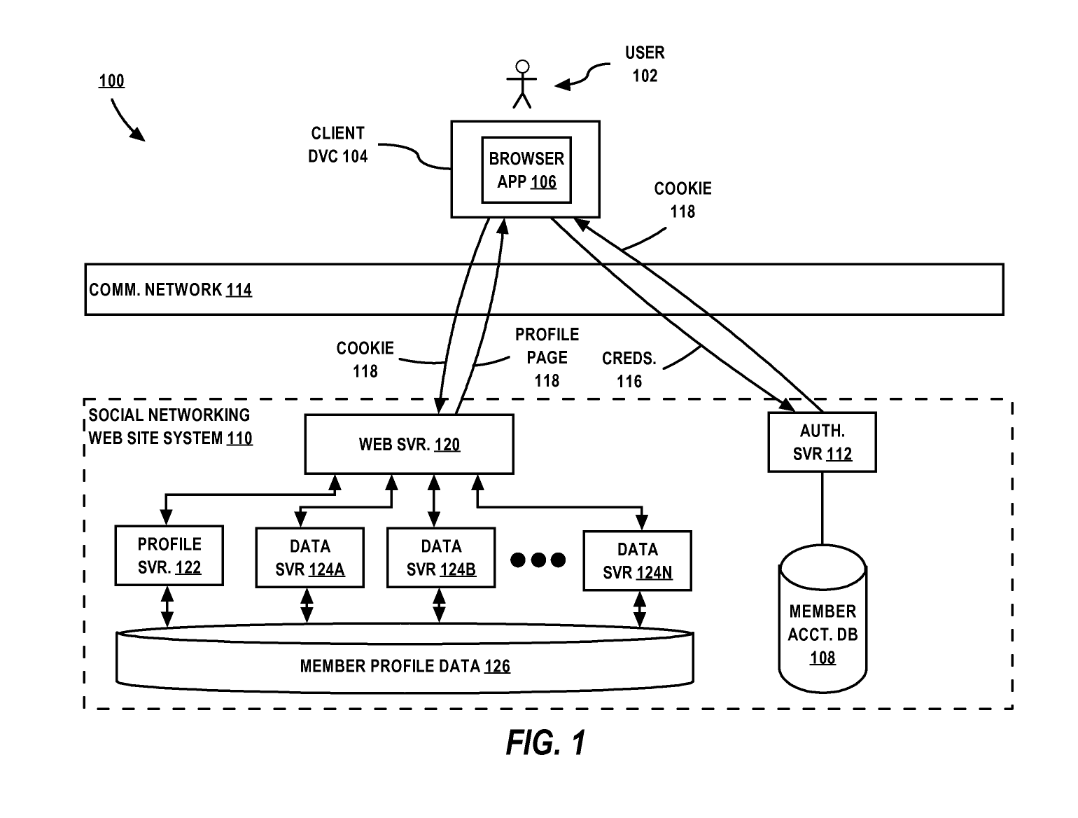

FIG. 1 is a block diagram illustrating computing environment 100 that includes social networking web site computer system 110 in accordance with some embodiments. Social networking web site computer system 110 (also referred to herein as “web site 110”) may be operated by the social networking service. The social networking service provides the social network to users of the web site 110 via web site 110.

Environment 100 includes a user 102. User 102 uses a personal computing device 104 to interact with web site 110. Personal computing device 104 may be configured with a conventional web browser application 106 for interacting with web site 110. Such interaction may include retrieving, presenting, and traversing web pages, including member profile pages, served by web site 110.

User 102 may be tasked with administering member profile pages of one or more members of the social network. For example, user 102 may be a customer or member support representative of the social networking service. Such administration may include changing one or more values in the member profile data of a member. For example, user 102 may be assigned a support ticket from a trouble ticketing system or other customer issue tracking system. The support ticket may identify a problem or issue with a particular member's profile. For example, the particular member may wish to change the appearance of the profile such as, for example, the photo of the member displayed on the profile, but may have been unable to figure out how to do so using web site 110.

According to some embodiments, user 102 is also a member of the social network. User 102 may be given one or more special administrative privileges through an authentication process used by web site 110 for authenticating members. The administrative privileges may allow user 102 to change member profile data maintained by web site 110 of one or more other members of the social network. As used herein, the term “administrative privilege” refers to a permission granted to a member of the social network that allows the member to modify the member profile data of at least one other member of the social network through the social networking web site.

According to some embodiments, an administrative privilege gives a particular user permission to modify member profile data of a class or type of member. For example, user 102 may be granted an administrative privilege that allows user 102 to administer the member profile pages of educational institutions such as colleges and universities. Another user may be granted an administrative privilege for administering the member profile pages of corporations and businesses.

As a result of being granted an administrative privilege for a specific class or type of member, user 102 may have the ability to administer the profile pages of only that class or type of member. For example, user 102 may be able to administer the profile pages of educational institutions but not the profile pages of corporations and businesses. However, it is also possible for a user to have administrative privileges for administering multiple classes or types of members. For example, user 102 may be granted permission through multiple administrative privileges or via a single administrative privilege to administer the member profile pages of educational institutions and the member profile pages of corporations and businesses.

### Administrative Privileges

According to some embodiments, a user may be granted one or more of the following administrative privileges:

TABLE 1
Exemplary Administrative Privileges

| Administrative Privilege | |
|---|---|
| Shorthand Name | Description |
| Manage Ad | Grants the user the ability to administer |
| | member profile pages representing an |
| | advertisement. |
| Manage Cap | Grants the user the ability to administer |
| | member profile pages associated with a |
| | recruiting product contract. |
| Manage Company | Grants the user the ability to administer |
| | member profile pages of a company or |
| | business. |
| Manage Group | Grants the user the ability to administer |
| | member profile pages of a group of members. |
| Manage Job | Grants the user the ability to administer |
| | member profile pages of a job opening or |
| | listing. |
| Manage University | Grants the user the ability to administer |
| | member profile pages of an educational |
| | institution such as a university or college. |
| Manage Editor | Grants the user the ability to access a portal to |
| | moderate and curate content that will be posted |
| | on member home page feeds. |

The above table lists just some examples of administrative privileges for a class or type of member. Administrative privileges for other classes or types of members are possible. For example, an administrative privilege may be based on the geographic location of members according to the member profile data. For example, a user may be granted permission through an administrative privilege to administer the member profile pages of members that reside in a particular state (e.g., California) or particular region (e.g., San Francisco Bay Area). More generally, an administrative privilege may be granted to a user for administering virtually any class, type, or group of members as defined based on values in the member profile data of the members.

### Granting Administrative Privileges

According to some embodiments, an administrative privilege is granted to a user via a browser cookie in response to successfully authenticating the user. For this, web site 110 may include a member account database 108. Member account database 108 may hold authentication information about some or all members of the social network including user 102. More specifically, for a given member of the social network, member account database 108 may store authentication credentials such as, for example, a username and password combination for the member. In addition, member account database 108 may store administrative privileges for some of the members. That is, for members of the social network that have at least one administrative privilege, member account database 108 may store for such a member a list of the administrative privileges that the member has. In a possible implementation, only a very small number of the total number of members in the social network may have an administrative privilege. For example, the social network may comprise millions or even billions of members and the number of those members with an administrative privilege may be in the tens or hundreds.

Web site 110 may include an authentication server 112 for authenticating users of web site 110 including user 102. To do so, authentication server 112 receives authentication credentials 116 of user 102 (e.g., a username and password combination) from client computing device 104 via communications network 114. If authentication server 112 successfully validates authentication credentials 116, then authentication server 112 sets a browser cookie 118 that is returned to the client computing device 104 via communications network 114. Browser cookie 118 may carry and encode any administrative privileges that user 102 has according to the user's 102 account record in member account database 108.

Within browser cookie 118, each administrative privilege that user 102 has may be represented. For example, the set of administrative privileges user 102 has may be represented as a Base64 encoded character string. Browser cookie 118 may also contain a digital signature for verifying the authenticity of the source of the encoded character string. In particular, web site 110 may use the digital signature to verify that the encoded character string representing user's 102 administrative privileges has not been tampered with when the encoded character string and the digital signature are sent back to web site 110 from client computing device 104. Browser cookie 118 can be a persistent browser cookie or a session browser cookie according to the requirements of the particular implementation at hand.

### Serving a Target Member's Profile Page in Administrative Mode

Web site 110 may also include a web server 120 for handling requests for profile pages of members of the social network. In this example, user 102 is a member of the social network and has at least one administrative privilege with respect to at least one other member of the social network. User 102 may request the profile page 128 of another member for the purpose of administering the profile page 128 of that member. This other user is sometimes referred to hereinafter as the “target member”. The target member is not limited to being a person but can instead be a company, group, association, school, advertisement, job posting, or other entity. For purposes of providing a clear example, user 102 is sometimes referred to hereinafter as “administrating user 102”, or just “administrator 102”.

Administrator 102 uses browser application 106 at client device 104 to request the profile page 128 of the target member. Web server 120 receives the request from communications network 114. The request may include browser cookie 118 issued to client device 104 by authentication server 112 in response to successfully authenticating user 102. The browser cookie 118 sent in the profile page request may encode one or more administrative privileges that administrator 102 has.

Requests of the authentication server 112 and the web server 120, and responses thereto, may be made according to application-level networking protocol such as, for example, the HyperText Transfer Protocol (HTTP) or a secure variant thereof (e.g., HTTPS). Communications network 114 may include a conventional Internet Protocol (IP) data network. For example, communications network 114 may include the Internet, a Wide Area Network (WAN), and/or a Local Area Network (LAN).

Upon receiving the request for the profile page 128 of the target user from client device 104, web server 102 forwards the request including any administrative privileges in browser cookie 118 to profile server 122. Profile server 122 determines “user interface (UI) embeds” to include in the profile page 128 returned to the client device 104. A UI embed is a section of a profile page. A profile page may have one or more UI embeds. For example, a profile page may have UI embeds for positions, summary, connections, followed members, etc.

### Administrative UI Embeds

According to some embodiments, the profile server 122 determines the UI embeds (to include in the profile page 128 returned to the client device 104) based on the administrative privileges of the administrator 102. In particular, profile server 122 may determine to include one or more “administrative” UI embeds in the profile page 128 based on the presence of an administrative privilege in the cookie 118. An administrative UI embed is a UI embed specially designed for administering profile pages. For example, an administrative UI embed may present a portion of change or audit log. The change or audit log may be display, on the profile page 128 of the target member, the last N (e.g., 5-10) number of edits to the member profile data 126 of the target member. In this way, administrator 102 can view recent edits to the member profile data 126 of the target member when viewing the profile page 128 of the target member and does not have to view a separate user interface to view the recent edits which could slow down the administrator's 102 current administrative task of administering the profile page 128 of the target member. As another example, an administrative UI embed may present user interface controls on the profile page 128 of the target member for modifying corresponding member profile data 126 of the target member. For example, an administrative UI embed may include user interface controls for changing the target member's display name, address, contact information, photo, or other information about the member in the member profile data 126 for the target member.

### Administrative Mode Indicator

According to some embodiments, the profile server 122 determines whether an indication that the administrator 102 has at least one administrative privilege with respect to the target member's profile page 128 should be displayed on the profile page 128. Such an indication is useful to the administrator 102 so that the administrator 102 is aware that he or she has administrative privileges with respect to the target member's profile page 182 and consequently potentially has the ability to modify the member profile data 126 of the target member through the profile page 128 (e.g., through user interface controls of an administrative UI embed presented on the profile page 128). Ordinarily, if administrator 102 does not have an administrative privilege with respect to the target member's profile page 128, then administrator 102 would not have the ability to modify the member profile data 126 of the target member through the profile page 128. An indication displayed on the target member's profile page that the user 102 has at least one administrative privilege with respect to the target member's profile page 128 is sometimes referred to hereinafter as the “administrative mode indicator.”

Profile server 122 may determine whether the administrative mode indicator should be displayed on the profile page 128 based on whether the user 102 has at least one administrative privilege with respect to the target member's profile page 128 as indicated in the browser cookie 118 sent in the request for the profile page 128 from the client device 104. The administrative mode indicator can take a variety of different visual forms and embodiments are not limited to any particular form. For example, the administrative mode indicator may take the form of a graphic, text, and/or image that provides the appropriate indication to user 102 that user 102 currently has administrative privileges with respect to the target member's profile page 128. For example, the administrative mode indicator may be displayed at the top or near the top of the target member's profile page 128 when displayed by the browser application 106 at the client device 104.

### Administrative User Interface Controls

When the profile server 122 determines that the user 102 currently has an administrative privilege with respect to the target member's profile page 128, the profile server 122 may determine to include administrative mode logout user interface controls (“admin logout controls”) and/or spam control user interface controls (“spam controls”) on the profile page 128 returned to the client device 104, in addition to or instead of the administrative mode indicator. In some embodiments, the admin logout controls, the spam controls, or both the admin logout controls and the spam controls serve as the administrative mode indicator.

The admin logout controls allow the user 102 to logout of administrative mode. In other words, the admin logout controls allow the user 102 to revoke the administrative privileges the user 102 currently has. In response to activating the admin logout controls on the profile page 128 as presented by the browser application 106, a request may be sent from the client device 104 to the authentication server 112 that includes the browser cookie 118. In response to receiving the request, the authentication server 112 may return a response back to the client device 104 that sets a new browser cookie 118 in the response with the administrative privileges removed from the set browser cookie 118. By doing this, the user 102 no longer has administrative privileges with respect to the target member's profile page 128. The administrative mode indicator, admin logout controls, spam controls, and any admin UI embeds may be removed from the profile page 128 (i.e., no longer displayed on the profile page 128) in response to receiving the new cookie 118 with the administrative privileges removed.

The spam controls allow the user 102 to toggle on and off whether designated spam content is displayed on the target member's profile page 128. Certain member profile data displayed on the target member's profile page 128 may be designated as spam content. Spam content includes advertising content, offensive content, abusive content, pornographic content, vulgar content, or other content that is deemed inappropriate or does not comply with content guidelines of the social networking service. For example, posts and comments may be tagged or flagged as spam content based on their contents. Such tagging or flagging may occur according to computerized supervised learning algorithms trained to identify spam content, for example. The spam controls allow the user 102 to selectively hide from display on the target member's profile page 128 content designated as spam content that would otherwise be displayed on the profile page 128.

After determining the UI embeds, including any administrative UI embeds, to be presented on the profile page 128, the profile server 122 returns a profile skeleton page to the web server 120. The profile skeleton page may include markup language instructions (e.g., HTML instructions) with multiple “embed directives,” one for each UI embed section of the profile page 128. However, the profile skeleton page returned to the web server 120 may not include, or include only a limited amount of, member profile data 126 of the target member. Instead, the member profile data 126 of the target member's profile to be displayed on the profile page 128 may be obtained by the web server 120 from one or more data servers 124A-N in response to processing the embed directives in the profile skeleton page. The profile skeleton page may also include markup language instructions for rendering the administrative mode indicator, the admin logout controls, and/or the spam controls, if the profile server 122 determined to include one or more of them in the profile page 128 returned to the client device 104.

Data servers 124A-N may be responsible for providing different types of member profile data 126 about a member in the social network. For example, one data server (e.g. 124A may provide member profile data 126 about the education institutions a given member attended while another data server (e.g., 124B) may provide member profile data 126 about the connections in the social network a given member has. In some embodiments, one or more of the data servers 124A-N provide information for presentation in an administrative UI embed on the profile page 128. For example, a data server may provide an audit log or change log data for a given member.

When the web server 120 receives the profile skeleton page from the profile server 122, the web server 120 processes each embed directive in the profile skeleton page. Each such embed directive may contain an identifier of a corresponding data server 124A-N from which the web server 120 can obtain member profile data 126 for presentation in the corresponding UI embed on the profile page 128. For example, the identifier may be a Uniform Resource Indicator (URI) or a portion thereof identifying the corresponding data server. For each embed directed in the profile skeleton page, the web server 102 obtains member profile data 126 from the corresponding data server 124A-N, incorporates the obtained member profile data 126 into the profile page 128, and returns the profile page 128 to client device 104.

Upon receiving the profile page 128 from web site 110, the profile page 128, or a portion thereof, may be displayed to the user 102 by browser application 106. If the user 102 has an administrative privilege with respect to the profile page 128, then one or more of the administrative more indicator, the administrative mode logout controls, the spam controls, and/or one or more administrative UI embeds may also be displayed as part of the profile page 128, or the portion thereof.

### Exemplary Administrative Mode Indicator

When user 102 has an administrative privilege with respect to the target member's profile page 128, an administrative mode indicator may be displayed on the profile page 128 so that the user 102 is visually informed that the user 102 currently has administrative privileges with respect to the target member's profile page 128. The administrative mode indicator can take a variety of different visual forms and embodiments of the present invention are not limited to any particular visual form. In some embodiments, the administrative mode indicator is displayed near to the top or beginning of the profile page 128 so as to be conspicuously visible to the user 102 when the user 102 views the profile page 128 after it has been loaded. For example, the administrative mode indicator may be displayed in a top navigation bar or panel displayed near or at the top or beginning of the profile page 128.

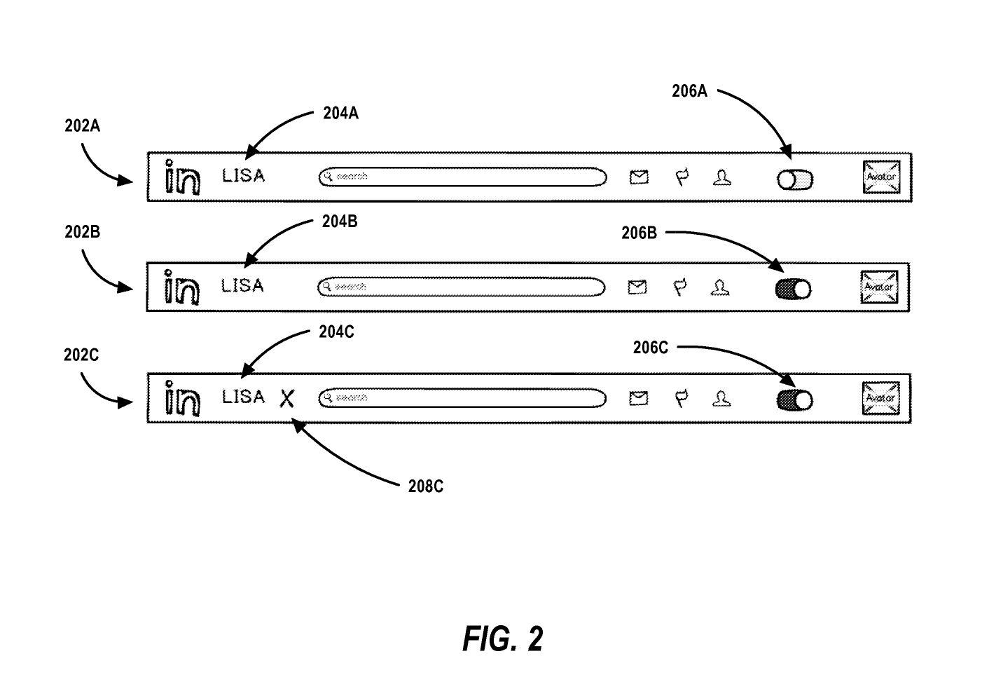

Attention is now directed to FIG. 2 which provides three examples 202A, 202B, and 202C of a possible top navigation bar that may be displayed on the target member's profile page 128 when the user 102 has at least one administrative privilege with respect to the target member's profile page 128. Each example 202A, 202B, and 202C includes an administrative mode indicator 204A, 204B, and 204C, respectively. The administrative mode indicator in this example is the text “LISA” which stands for “LinkedIn Super Admin.” LinkedIn Corporation is a business-oriented social networking service with headquarters in Mountain View, Calif. The example administrative mode indicator provided in FIG. 2 is just one example of a possible administrative mode indicator and the administrative mode indicator may take other graphical forms in other embodiments. The administrative mode indicator 204 is displayed on the profile page 128 only if the user 102 has at least one administrative privileged with respect to the profile page 128. If the user 102 currently does not have any administrative privileges with respect to the profile page 128, then the administrative mode indicator 204 would not be displayed on the profile page 128. By viewing the presence or the absence of administrator mode indicator 204, the user 102 can tell whether the user 102 currently has administrative mode privileges with respect to the target member's profile page 128. In particular, if the administrator mode indicator 204 is present on the profile page 128, then the user 102 can tell that he or she has administrative mode privileges with respect to the target member's profile page 128. Alternatively, if the administrator mode indicator 204 is not present on the profile page 128, then the user 102 can tell that he or she does not have administrative mode privileges with respect to the target member's profile page 128.

Each example 202A, 202B, and 202C also includes spam controls 206A, 206B, and 206C, respectively. In example 202A, spam control 206A is in a deactivated state. In the deactivated state, any designated spam content of the profile page 128 will be viewable on the profile page 128. In examples 202B and 202C, spam controls 206B and 206C are in the activated state. In the activated state, any designated spam content of the profile page 128 will not be viewable on the profile page 128. In some implementations, if the spam controls (e.g., 206B) are in the activated state, the designated spam content is not included in the profile page 128 sent to the client device 104. The user 102 can toggle the spam controls 206 with user input (e.g., mouse click or tough gesture) between the deactivated and activated state to reveal or hide spam content.

Example 202C also includes administrative mode logout control 208C. If activated by user 102 input, the administrative privileges of the user 102 are revoked. Revoking the administrative privileges may be accomplished by sending a request from the client device 104 to the authentication server 112 containing the browser cookie 118 with the administrative privileges. In response to receiving the request, the authentication server 112 sets a new cookie 18 to replace the current cookie 118 that does not contain the administrative privileges.

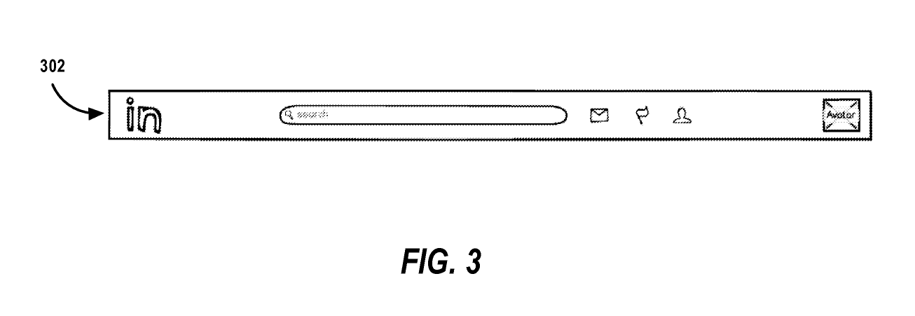

FIG. 3 shows an example 302 of the top navigation bar of the profile page 128 after the user 102 has activated administrative logout control 208C. Since the user 102 no longer has any administrative privileges with respect to the target member's profile page 128 after logging out of administrative mode, the administrative mode indicator, the administrative mode logout controls, and the spam controls are no longer displayed on the profile page 128.

### Example Process

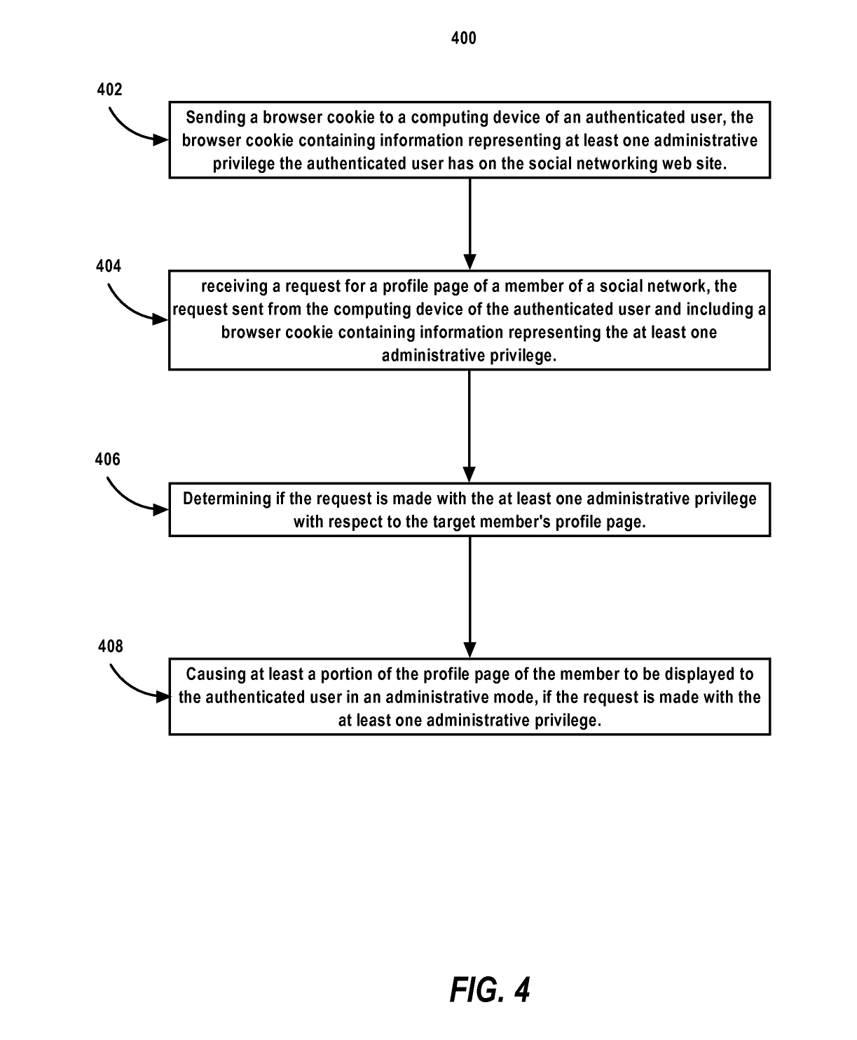

Turning now to FIG. 4, it is a flowchart of a computer-implemented process 400 for administering the member profile page of a target member of a social network by a user who also a member of the social network but is not the member. The process 400 may be performed by one or more computing devices of a social networking web site such as, for example, web site 110. For purposes of providing a clear example, the member of the social network that is tasked with administering the target member's profile page is referred to hereinafter as “the administrator.”

The process begins at step 402 where the web site 110 sends a browser cookie to a computing device 104 of the administrator 102. The browser cookie may be a persistent browser cookie or session browser cookie. For example, the browser cookie may be sent to the computing device 104 of the administrator 102 in a HTTP or HTTPS response to a HTTP or HTTPS request to authenticate authentication credentials (e.g., a username and password pair) provided by the administrator 102. The browser cookie sent to the administrator's 102 computing device 104 may contain one or more privileges that the administrator has, according to a user account database maintained by the social networking web site 110 service. These privileges can include just administrative privileges, just non-administrative privileges, and both administrative and non-administrative privilege. An administrative privilege may be a privilege that grants a member permission to modify the member profile data maintained by the social network web site 110 service of at least one other member of the social network through the other member's profile page. A non-administrative privilege may be a privilege that grants the member permission to modify his or her own member profile data through the member's own profile page. Typically, a user that has an administrative privilege is an employee or representative of the social networking web site 110 service such as, for example, a member or customer support representative.

Next, at step 404, the web site 110 receives a request for the profile page 128 of the target member from the computing device 104 of the administrator 102. For example, the web site 110 may receive a HTTP or HTTPS request with a URL, or a portion thereof, that identifies the target member's profile page 128. The request may include the browser cookie 118 sent in step 402. In particular, the browser cookie 118 may include any administrative privileges that were sent in the browser cookie 118 at step 402.

Next at step 406, the web site 110 determines if the request for the profile page 128 of the target member from the computing device 104 of the administrator 102 was made with at least one administrative privilege with respect to the target member's profile page 128. This determination may be made by inspecting the browser cookie 118 sent in the request for any administrative privileges that the administrator 102 has.

In some instances, the determination made at step 406 is made with respect to the target member. That is, the administrator 102 is considered to have an administrative privilege with respect to the requested profile page 128 if the browser cookie 118 indicates that the administrator 102 has an administrator privilege with respect to a class of members to which the target member belongs. For example, the administrator 102 may have, as indicated in the browser cookie 118, an administrative privilege with respect to the class of educational institution members. In this case, the web site 110 may determine that the request for the profile page 128 is made with an administrative privilege if the target member is a university or a college, for example. But if the target member is a job listing or a business or corporation, then the web site 110 may determine that the request for the profile page 128 is not made with an administrative privilege with respect to the target member's profile page 128.

At step 408, if the request for the profile page 128 received at step 406 is made with an administrative privilege with respect to the profile page 128, then the requested profile page 128 is served to the computing device 104 of the administrator 102 in an administrative mode. In particular, the profile page 128 may be sent to with an administrative mode indicator (e.g., administrator mode indicator 2064A), administrative mode logout user interface controls (e.g., 208C), spam controls (e.g., 206A), and/or one or more administrative UI embeds. On the other hand, if the request for the profile page 128 is not made with an administrative privilege with respect to the profile page 128, then the requested profile page 128 is served but without any of these administrative features. In other words, the profile page 128 appears to the administrator 102 without an administrator mode indicator, administrative mode logout controls, spam controls, or any administrative UI embeds. Thus, if the request for the profile page 128 is not made with an administrative privilege with respect to the profile page 128, then the profile page 128 may appear to the user 102 according to any non-administrative privileges the user 102 has.

### Example Basic Computing Hardware

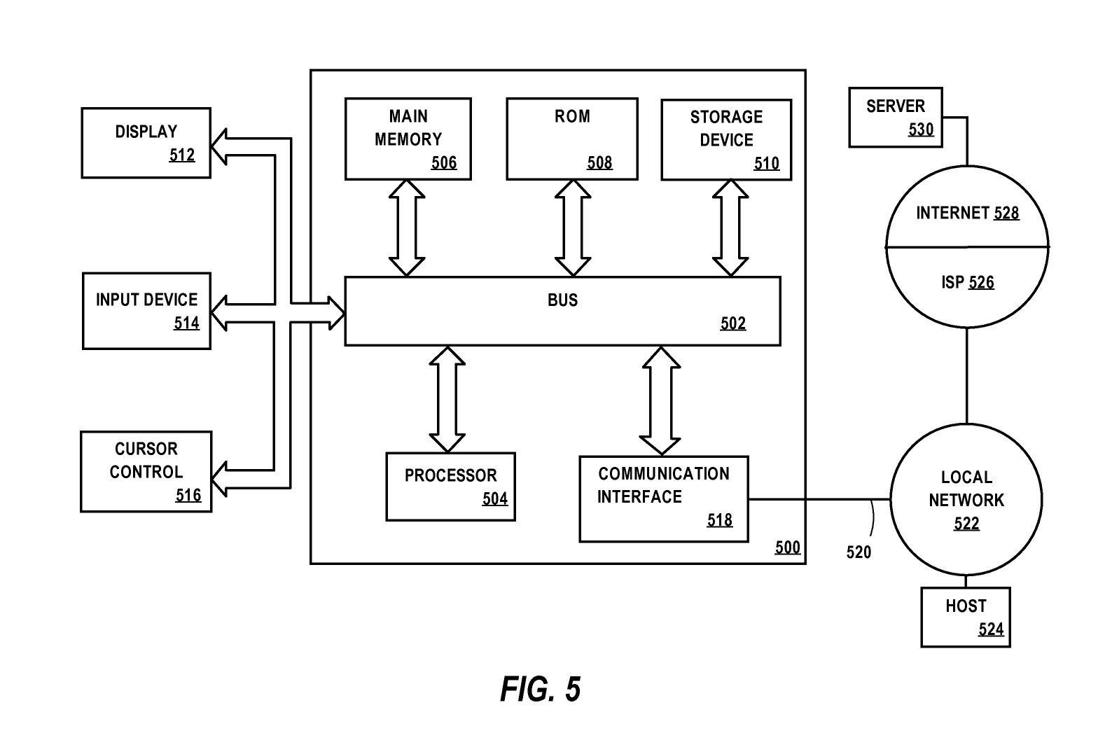

Referring now to FIG. 5, it is a block diagram that illustrates an example computing device 500. Computing device 500 and its components, including their connections, relationships, and functions, is meant to be exemplary only, and not meant to limit implementations of the present invention. Other computing devices suitable for implementing the present invention may have different components, including components with different connections, relationships, and functions.

Computing device 500 may include a bus 502 or other communication mechanism for addressing main memory 506 and for transferring data between and among the various components of device 500.

Computing device 500 may also include one or more hardware processors 504 coupled with bus 502 for processing information. A hardware processor 504 may be a general purpose microprocessor, a system on a chip (SoC), or other processor suitable for implementing the present invention.

Main memory 506, such as a random access memory (RAM) or other dynamic storage device, also may be coupled to bus 502 for storing information and instructions to be executed by processor(s) 504. Main memory 506 also may be used for storing temporary variables or other intermediate information during execution of software instructions to be executed by processor(s) 504. Such software instructions, when stored in non-transitory storage media accessible to processor(s) 504, render computing device 500 into a special-purpose computing device that is customized to perform the operations specified in the instructions. The terms “instructions”, “software”, “software instructions”, “program”, “computer program”, “computer-executable instructions”, and “processor-executable instructions” are to be broadly construed to cover any machine-readable information, whether or not human-readable, for instructing a computing device to perform specific operations, and including, but not limited to, application software, desktop applications, scripts, binaries, operating systems, device drivers, boot loaders, shells, utilities, system software, Javascript, web pages, web applications, plugins, embedded software, microcode, compilers, debuggers, interpreters, virtual machines, linkers, and text editors.

Computing device 500 also may include read only memory (ROM) 508 or other static storage device coupled to bus 502 for storing static information and instructions for processor(s) 504.

One or more mass storage devices 510 may be coupled to bus 502 for persistently storing information and instructions on fixed or removable media, such as magnetic, optical, solid-state, magnetic-optical, flash memory, or any other available mass storage technology. The mass storage may be shared on a network, or it may be dedicated mass storage. Typically, at least one of the mass storage devices 510 (e.g., the main hard disk for the device) stores a body of program and data for directing operation of the computing device, including an operating system, user application programs, driver and other support files, as well as other data files of all sorts.

Computing device 500 may be coupled via bus 502 to display 512, such as a liquid crystal display (LCD) or other electronic visual display, for displaying information to a computer user. In some configurations, a touch sensitive surface incorporating touch detection technology (e.g., resistive, capacitive, etc.) may be overlaid on display 512 to form a touch sensitive display for communicating touch gesture (e.g., finger or stylus) input to processor(s) 504.

An input device 514, including alphanumeric and other keys, may be coupled to bus 502 for communicating information and command selections to processor 504. In addition to or instead of alphanumeric and other keys, input device 514 may include one or more physical buttons or switches such as, for example, a power (on/off) button, a “home” button, volume control buttons, or the like.

Another type of user input device may be a cursor control 516, such as a mouse, a trackball, or cursor direction keys for communicating direction information and command selections to processor 504 and for controlling cursor movement on display 512. This input device typically has two degrees of freedom in two axes, a first axis (e.g., x) and a second axis (e.g., y), that allows the device to specify positions in a plane.

While in some configurations, such as the configuration depicted in FIG. 5, one or more of display 512, input device 514, and cursor control 516 are external components (i.e., peripheral devices) of computing device 500, one or more of display 512, input device 514, and cursor control 516 are integrated as part of the form factor of computing device 500 in other configurations.

Functions of the disclosed systems, methods, and modules may be performed by computing device 500 in response to processor(s) 504 executing one or more programs of software instructions contained in main memory 506. Such instructions may be read into main memory 506 from another storage medium, such as storage device(s) 510. Execution of the software program instructions contained in main memory 506 cause processor(s) 504 to perform the functions of the disclosed systems, methods, and modules.

While in some implementations, functions of the disclosed systems and methods are implemented entirely with software instructions, hard-wired or programmable circuitry of computing device 500 (e.g., an ASIC, a FPGA, or the like) may be used in place of or in combination with software instructions to perform the functions, according to the requirements of the particular implementation at hand.

The term “storage media” as used herein refers to any non-transitory media that store data and/or instructions that cause a computing device to operate in a specific fashion. Such storage media may comprise non-volatile media and/or volatile media. Non-volatile media includes, for example, optical disks, magnetic disks, or solid-state drives, such as storage device 510. Volatile media includes dynamic memory, such as main memory 506. Common forms of storage media include, for example, a floppy disk, a flexible disk, hard disk, solid-state drive, magnetic tape, or any other magnetic data storage medium, a CD-ROM, any other optical data storage medium, any physical medium with patterns of holes, a RAM, a PROM, and EPROM, a FLASH-EPROM, NVRAM, any other memory chip or cartridge.

Storage media is distinct from but may be used in conjunction with transmission media. Transmission media participates in transferring information between storage media. For example, transmission media includes coaxial cables, copper wire and fiber optics, including the wires that comprise bus 502. Transmission media can also take the form of acoustic or light waves, such as those generated during radio-wave and infra-red data communications.

Various forms of media may be involved in carrying one or more sequences of one or more instructions to processor(s) 504 for execution. For example, the instructions may initially be carried on a magnetic disk or solid-state drive of a remote computer. The remote computer can load the instructions into its dynamic memory and send the instructions over a telephone line using a modem. A modem local to computing device 500 can receive the data on the telephone line and use an infra-red transmitter to convert the data to an infra-red signal. An infra-red detector can receive the data carried in the infra-red signal and appropriate circuitry can place the data on bus 502. Bus 502 carries the data to main memory 506, from which processor(s) 504 retrieves and executes the instructions. The instructions received by main memory 506 may optionally be stored on storage device(s) 510 either before or after execution by processor(s) 504.

Computing device 500 also may include one or more communication interface(s) 518 coupled to bus 502. A communication interface 518 provides a two-way data communication coupling to a wired or wireless network link 520 that is connected to a local network 522 (e.g., Ethernet network, Wireless Local Area Network, cellular phone network, Bluetooth wireless network, or the like). Communication interface 518 sends and receives electrical, electromagnetic, or optical signals that carry digital data streams representing various types of information. For example, communication interface 518 may be a wired network interface card, a wireless network interface card with an integrated radio antenna, or a modem (e.g., ISDN, DSL, or cable modem).

Network link(s) 520 typically provide data communication through one or more networks to other data devices. For example, a network link 520 may provide a connection through a local network 522 to a host computer 524 or to data equipment operated by an Internet Service Provider (ISP) 526. ISP 526 in turn provides data communication services through the world wide packet data communication network now commonly referred to as the “Internet” 528. Local network(s) 522 and Internet 528 use electrical, electromagnetic or optical signals that carry digital data streams. The signals through the various networks and the signals on network link(s) 520 and through communication interface(s) 518, which carry the digital data to and from computing device 500, are example forms of transmission media.

Computing device 500 can send messages and receive data, including program code, through the network(s), network link(s) 520 and communication interface(s) 518. In the Internet example, a server 530 might transmit a requested code for an application program through Internet 528, ISP 526, local network(s) 522 and communication interface(s) 518.

The received code may be executed by processor 504 as it is received, and/or stored in storage device 510, or other non-volatile storage for later execution.

### Example Basic Software System

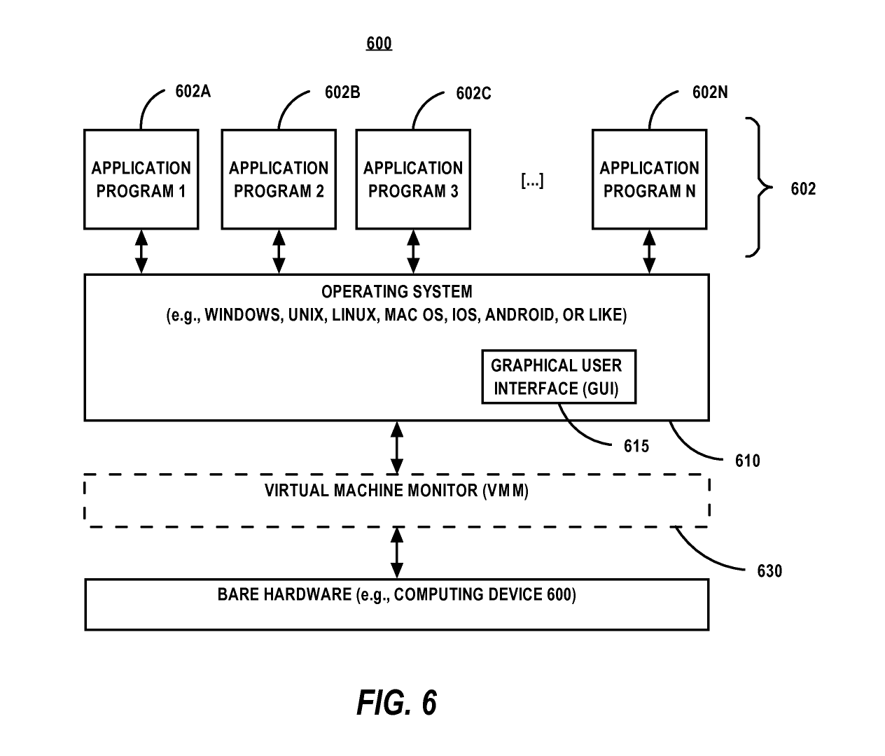

FIG. 6 is a block diagram of an example software system 600 that may be employed for controlling the operation of computing device 500. As shown, a computer software system 600 is provided for directing the operation of computing device 500. Software system 600, which may be stored in system memory (RAM) 506 and on fixed storage (e.g., hard disk) 510, includes a kernel or operating system (OS) 610. The OS 610 manages low-level aspects of computer operation, including managing execution of processes, memory allocation, file input and output (I/O), and device I/O. One or more application programs (e.g., client application 112 of FIG. 1) or modules (e.g., 132, 134, 136, 138, 140, 142, and 144 of FIG. 1), represented as 602A, 602B, 602C . . . 602N in FIG. 6, may be “loaded” (i.e., transferred from fixed storage 610 into memory 606) for execution by the system 400. The applications or other software intended for use on device 600 may also be stored as a set of downloadable computer-executable instructions, for example, for downloading and installation from an Internet location (e.g., Web server).

Software system 600 may include a graphical user interface (GUI) 615, for receiving user commands and data in a graphical (e.g., “point-and-click” or “touch gesture”) fashion. These inputs, in turn, may be acted upon by the system 600 in accordance with instructions from operating system 610 and/or client application module(s) 602. The GUI 615 also serves to display the results of operation from the OS 610 and application(s) 602, whereupon the user may supply additional inputs or terminate the session (e.g., log off).

OS 610 can execute directly on the bare hardware (e.g., processor(s) 504) 620 of device 500. Alternatively, a hypervisor or virtual machine monitor (VMM) 630 may be interposed between the bare hardware 620 and the OS 610. In this configuration, VMM 630 acts as a software “cushion” or virtualization layer between the OS 610 and the bare hardware 620 of the device 500.

VMM 630 instantiates and runs virtual machine instances (“guest machines”). Each guest machine comprises a “guest” operating system, such as OS 610, and one or more applications, such as applications 602, designed to execute on the guest operating system. The VMM 630 presents the guest operating systems with a virtual operating platform and manages the execution of the guest operating systems.

In some instances, the VMM 630 may allow a guest operating system to run as if it is running on the bare hardware 620 of device 500 directly. In these instances, the same version of the guest operating system configured to execute on the bare hardware 620 directly may also be able to execute on VMM 630 without modification or reconfiguration. In other words, VMM 630 may provide full hardware and CPU virtualization to a guest operating system in some instances.

In other instances, a guest operating system may be specially designed or configured to execute on VMM 630 for efficiency. In these instances, the guest operating system is “aware” that it executes on a virtual machine monitor. In other words, VMM 630 may provide para-virtualization to a guest operating system in some instances.

The above-described computer hardware and software is presented for purpose of illustrating example underlying computer components that may be employed for implementing the present invention. The present invention, however, is not necessarily limited to any particular computing environment or computing device configuration. Instead, the present invention may be implemented in any type of system architecture or processing environment capable of supporting the features and functions of the disclosed systems and methods.

### EXTENSIONS AND ALTERNATIVES

While exemplary embodiments described above are in the context of a social networking web site, one skilled in the art will recognize from the description that the embodiments may be implemented in the context of other types of web sites. Thus, the present invention is not limited to social networking web sites or any particular type of web site.

In the foregoing specification, embodiments of the invention have been described with reference to numerous specific details that may vary from implementation to implementation. The illustrative discussions above are not intended to be exhaustive or to limit the invention to the precise forms disclosed. Many modifications are variations are possible in view of the above teachings. The specification and drawings are, accordingly, to be regarded in an illustrative rather than a restrictive sense.

1. A social networking web site system comprising:
one or more hardware processors;
memory;
one or more programs stored in the memory that, when executed by the one or more hardware processors, cause the one or more hardware processor to:
send, via at least one of the one or more hardware processors, a browser cookie to a computing device of an authenticated user, the browser cookie containing information representing at least one administrative privilege the authenticated user has on the social networking web site;
receive, via at least one of the one or more hardware processors, a request for a profile page of a member of a social network, the request sent from the computing device of the authenticated user and including the browser cookie containing information representing the at least one administrative privilege;
wherein the member is not the authenticated user;
determine, via at least one of the one or more hardware processors, based on the browser cookie in the request, if the request is made with the at least one administrative privilege; and
cause, via at least one of the one or more hardware processors, at least a portion of the profile page of the member to be displayed to the authenticated user with a visual indication on the portion of the profile page that the authenticated user currently has the at least one administrative privilege with respect to the profile page of the member, if the request is made with the at least one administrative privilege.

2. The system of claim 1, wherein the one or more programs stored in the memory, when executed by the one or more hardware processors, further cause the one or more hardware processor to:
cause, via at least one of the processors, user interface controls, for administering the member's profile page, to be displayed to the authenticated user on the portion of the profile page of the member, if the request is made with the at least one administrative privilege.

3. The system of claim 2, further comprising a database storing member profile data of the member; and wherein the user interface controls allow the authenticated user to modify member profile data of the member.

4. The system of claim 1, wherein the one or more programs stored in the memory, when executed by the one or more hardware processors, further cause the one or more hardware processor to:
cause, via at least one of the processors, a plurality of profile change log entries to be displayed to the authenticated user on the portion of the profile page, if the request is made with the at least one administrative privilege; and
wherein each profile change log entry reflects a historical change to member profile data of the member.

5. The system of claim 1, wherein the member is not a person.

6. The system of claim 1, wherein the one or more programs stored in the memory, when executed by the one or more hardware processors, further cause the one or more hardware processor to:
cause, via at least one of the processors, user interface controls to be displayed to the authenticated user on the portion of the profile page of the member, if the request is made with the at least one administrative privilege; and
wherein the user interface controls, if activated by the authenticated user, cause the at least one administrative privilege to be revoked from the authenticated user.

7. The system of claim 1, wherein the one or more programs stored in the memory, when executed by the one or more hardware processors, further cause the one or more hardware processor to:
cause, via at least one of the processors, user interface controls to be displayed to the authenticated user on the portion of the profile page of the member, if the request is made with the at least one administrative privilege; and
wherein the user interface controls, if activated by the authenticated user, cause designated spam content displayed on the portion of the profile page to no longer be displayed on the profile page; and
wherein the user interface controls, if deactivated by the authenticated user, cause the designated spam to be displayed on the portion of the profile page.

8. The system of claim 1, wherein the at least one administrative privilege grants the authenticated user permission to administer the member profile pages of a class of members to which the member belongs.

9. A computer-implemented method performed by one or more computing devices of a social networking web site, the method comprising:
sending, via at least one of the one or more computing devices, a browser cookie to a computing device of an authenticated user, the browser cookie containing information representing at least one administrative privilege the authenticated user has on the social networking web site;
receiving, via at least one of the computing devices, a request for a profile page of a member of a social network, the request sent from the computing device of the authenticated user and including a browser cookie containing information representing the at least one administrative privilege;
wherein the member is not the authenticated user;
determining, via at least one of the computing devices, based on the browser cookie in the request, if the request is made with the at least one administrative privilege; and
causing, via at least one of the computing devices, at least a portion of the profile page of the member to be displayed to the authenticated user with a visual indication on the portion of the profile page that the authenticated user currently has the at least one administrative privilege with respect to the member's profile page, if the request is made with the at least one administrative privilege.

10. The method of claim 9, further comprising:
causing, via at least one of the computing devices, user interface controls, for administering the member's profile page, to be displayed to the authenticated user on the portion of the profile page of the member, if the request is made with the at least one administrative privilege.

11. The method of claim 10, further comprising:
storing member profile data of the member in a database; and
wherein the user interface controls allow the authenticated user to modify the member profile data of the member.

12. The method of claim 9, further comprising:
causing, via at least one of the computing devices, a plurality of profile change log entries to be displayed to the authenticated user on the portion of the profile page, if the request is made with the at least one administrative privilege; and
wherein each profile change log entry reflects a historical change to member profile data of the member.

13. The method of claim 9, wherein the member is not a person.

14. The method of claim 9, further comprising:
causing, via at least one of the computing devices, user interface controls to be displayed to the authenticated user on the portion of the profile page of the member, if the request is made with the at least one administrative privilege; and
wherein the user interface controls, if activated by the authenticated user, cause the at least one administrative privilege to be revoked from the authenticated user.

15. The method of claim 9, further comprising:
causing, via at least one of the computing devices, user interface controls to be displayed to the authenticated user on the portion of the profile page of the member, if the request is made with the at least one administrative privilege;
wherein the user interface controls, if activated by the user, cause designated spam content displayed on the portion of the profile page to no longer be displayed on the profile page; and
wherein the user interface controls, if deactivated by the user, cause the designated spam to be displayed on the portion of the profile page.

16. The method of claim 9, wherein the at least one administrative privilege grants the authenticated user permission to administer the member profile pages of a class of members to which the member belongs.

17. A graphical user interface on a video display of, or operatively coupled to, a computing device of an authenticated user of a social networking web site, the graphical user interface comprising:
at least a portion of a profile page of a member, other than the authenticated user, of a social network; and
wherein in response to receiving a request for the profile page of the member from the computing device of the authenticated user: an administrative privilege that the authenticated user has with respect to the member's profile page is determined based on a browser cookie in the request, and a visual indication that the authenticated user has the administrative privilege with respect to the member's profile page is displayed on the portion of the profile page.

18. One or more non-transitory computer-readable media storing one or more programs, the one or more programs comprising instructions that, when executed by at least one computing device of a social networking web site, cause the at least one computing device to:
send a browser cookie to a computing device of an authenticated user, the browser cookie containing information representing at least one administrative privilege the authenticated user has on the social networking web site;
receive a request for a profile page of a member of a social network, the request sent from the computing device of the authenticated user and including a browser cookie containing information representing the at least one administrative privilege;
wherein the member is not the authenticated user;
determine based on the browser cookie in the request, if the request is made with the at least one administrative privilege; and
cause at least a portion of the profile page of the member to be displayed to the authenticated user with a visual indication on the portion of the profile page that the authenticated user currently has the at least one administrative privilege with respect to the member's profile page, if the request is made with the at least one administrative privilege.

19. The one or more non-transitory computer-readable media of claim 18, the one or more programs further comprising instructions for:
causing, via at least one computing device of the social networking web site, user interface controls, for administering the member's profile page, to be displayed to the authenticated user on the portion of the profile page of the member, if the request is made with the at least one administrative privilege.

20. The one or more non-transitory computer-readable media of claim 19, the one or more programs further comprising instructions for:
storing, via at least one computing device of the social networking web site, member profile data of the member in a database; and
wherein the user interface controls allow the authenticated user to modify the member profile data of the member.

21. The one or more non-transitory computer-readable media of claim 18, the one or more programs further comprising instructions for:
causing, via at least one computing device of the social networking web site, a plurality of profile change log entries to be displayed to the authenticated user on the portion of the profile page, if the request is made with the at least one administrative privilege; and
wherein each profile change log entry reflects a historical change to member profile data of the member.

22. The one or more non-transitory computer-readable media of claim 18, wherein the member is not a person.

23. The one or more non-transitory computer-readable media of claim 18, the one or more programs further comprising instructions for:
causing, via at least one computing device of the social networking web site, user interface controls to be displayed to the authenticated user on the portion of the profile page of the member, if the request is made with the at least one administrative privilege; and
wherein the user interface controls, if activated by the authenticated user, cause the at least one administrative privilege to be revoked from the authenticated user.

24. The one or more non-transitory computer-readable media of claim 18, the one or more programs further comprising instructions for:
causing, via at least one computing device of the social networking web site, user interface controls to be displayed to the authenticated user on the portion of the profile page of the member, if the request is made with the at least one administrative privilege;
wherein the user interface controls, if activated by the user, cause designated spam content displayed on the portion of the profile page to no longer be displayed on the profile page; and
wherein the user interface controls, if deactivated by the user, cause the designated spam to be displayed on the portion of the profile page.

25. The one or more non-transitory computer-readable media of claim 18, wherein the at least one administrative privilege grants the authenticated user permission to administer the member profile pages of a class of members to which the member belongs.
